(19) United States
(12) Patent Application Publication
(10) Pub. No.: US 2007/0113793 A1
(43) Pub. Date: May 24, 2007

(54) Pet toilet and disposable sheet for the same

(76) Inventors: Yasuhito Kurahashi, Okazaki-shi (JP); Masamitsu Kurahashi, Okazaki-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/654,797

(22) Filed: Jan. 17, 2007

(30) Foreign Application Priority Data
Jun. 2, 2004 (JP) 2004-164120
May 6, 2005 (JP) 2005-134782

(51) Int. Cl. A01K 1/03; A01K 1/035

(52) U.S. Cl. 119/479; 119/169

(57) ABSTRACT

A pet toilet is disposed at a corner area in an enclosure. The toilet includes a receiving tray having a corner area shaped roughly along the shape of a corner area of the enclosure, a covering member placed above the receiving tray with a number of through-holes penetrated, and a disposable sheet disposed on the receiving tray and including a storage part for receiving excrement, a screen erected at the base part side of the storage part, and a linkage part to link the storage part and the screen with each other. The storage part has its upper surface partially exposed at a portion close to a corner area of the receiving tray and is covered by the covering member at a portion spaced from the corner area of the receiving tray.

### FIELD OF THE INVENTION

The present invention relates to a toilet for a pet which is raised in an enclosure such as a cage, and a disposable sheet for the toilet.

### Description of the Related Art

There exists many conventional pet toilets. As one example of such prior arts, Japanese Published Unexamined Patent Application Nos. 2002-142599 and 2003-235389 are mentioned.

Also, there are some pet toilets where sand is placed, and urine and feces are adsorbed by the sand. Japanese Published Unexamined Patent Application No. 2004-0490303 may be listed as one example of such toilets. The toilet is provided with a sand-excluding-plate to eliminate the problem of soiling the indoors since a pet plays while stirring about the sand and walks around with sand adhered to its four paws. However, it is difficult with such an invention to completely remove sand adhered to the four paws of a pet, the problem of soiling a raising chamber cannot be solved yet. Also, since, for example, a pet ferret eats sand and will suffer from indigestion, it is preferable that a toilet does not use sand.

Further, the ferret is in the habit of defecating with its buttocks turned to a corner direction of a raising chamber. At this time, urine is discharged downward, and feces are discharged rearward. While most of feces drop at the corner area, portions thereof scatter sideward. Therefore, with the conventional toilets, there is a problem in that a corner area of the raising chamber is soiled.

To the contrary, as a pet toilet suitable for being placed at a corner area of the raising chamber and having side faces to receive feces scattering in side directions, Japanese Utility Model Publication No. 3056311 may be mentioned. However, with the pet toilet according to the Utility Model, it is very cumbersome that the floor structure thereof is removed and it is necessary to wash the entirety of the pet toilet.

It is therefore an object of the present invention to solve various problems of the conventional pet toilets, and particularly preferable, to provide a toilet for a pet which is in the habit of defecating with its buttocks turned to a corner area of the raising chamber.

### SUMMARY OF THE INVENTION

For achieving the objectives of the present invention, A pet toilet, disposed at a corner area in an enclosure in which a pet is accommodated, for a pet having the habit of defecating or urinating at a corner area of the enclosure is provided in the present invention. The pet toilet comprises a receiving tray having a corner area shaped roughly along the shape of a corner area of the enclosure, a covering member placed above the receiving tray so as to cover the upper surface of the receiving tray, having a portion, which is at a corner area adjacent to the corner area of the enclosure, cut off, and simultaneously including a number of through-holes penetrated from the surface to the back thereof, and a disposable sheet disposed on the receiving tray and including a storage part for receiving excrement, a screen erected at the base part side of the storage part, and a linkage part to link the storage part and the screen with each other, wherein the storage part has its upper surface partially exposed at a portion close to a corner area of the receiving tray and is covered by the covering member at a portion spaced from the corner area of the receiving tray.

Also for achieving the objectives of the present invention, a disposable sheet, which is disposed between a receiving tray and a covering member, for a toilet used for a pet including a receiving tray having a corner area shaped roughly along the shape of a corner area of an enclosure in which a pet is accommodated, and a covering member placed above the receiving tray so as to cover the upper surface of the receiving tray and having a number of through-holes penetrating from the surface to the back thereof is provided in the present invention.

The disposable sheet comprises a storage part for receiving excrement, a part of which is exposed at a corner area of the receiving tray when being placed on the receiving tray, and a portion spaced from the corner area of the receiving tray is covered by the covering member, a screen erected from the base part side of the storage part shaped along the shape of the corner area of the receiving tray, and a linkage part for linking the storage part and the screen with each other.

Other aspects and advantages of the present invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objectives and advantages thereof, may best be understood by reference to the following description of the present preferred embodiments together with the accompanying drawings in which:

FIG. 1 is a perspective view showing a toilet for a pet according to Embodiment 1;

FIG. 2 is a plan-view showing a pet toilet according to Embodiment 1, with a part thereof cut off.

FIG. 3 is a perspective view showing a disassembled state of the pet toilet according to Embodiment 1;

FIG. 4 is a sectional view taken along the line J₁- J₁ of FIG. 3 according to Embodiment 1;

FIG. 5 is a sectional view taken along the line L₁-L₁ of FIG. 3 according to Embodiment 1;

FIG. 6 is a sectional view taken along the line K₁-K₁ of FIG. 3 according to Embodiment 1;

FIGS. 7a and 7b are partially sectional views showing a holding mechanism, which is another mode different from Embodiment 1;

FIGS. 8a through 8c are partially sectional views showing a fixing mechanism, which is another mode different from Embodiment 1;

FIG. 9 is a perspective view showing a toilet for a pet, which is disposed in a cage according to Embodiment 2;

FIG. 10 is a perspective view showing a toilet for a pet according to Embodiment 2;

FIG. 11 is a disassembled perspective view showing a toilet for a pet according to Embodiment 2;

FIG. 12 is a plan view showing a toilet for a pet according to Embodiment 2;

FIG. 13 is a sectional view taken along the line A₁-A₁ of FIG. 12 according to Embodiment 2;

FIG. 14 is a developed view of a disposable sheet according to Embodiment 2;

FIG. 15a is a perspective view showing an assembled state of the disposable sheet according to Embodiment 2, and FIG. 15b is a perspective view showing an inverted V-shaped bending line in a bent state;

FIG. 16 is a partial plan view showing a screen according to Embodiment 2;

FIG. 17 is a sectional view showing a draining board, which is taken along the line B₁-B₁ of FIG. 12 according to Embodiment 2; and

FIG. 18 is a perspective view showing a toilet for a pet, the area of an opening of which is larger than in FIG. 10 according to Embodiment 2.

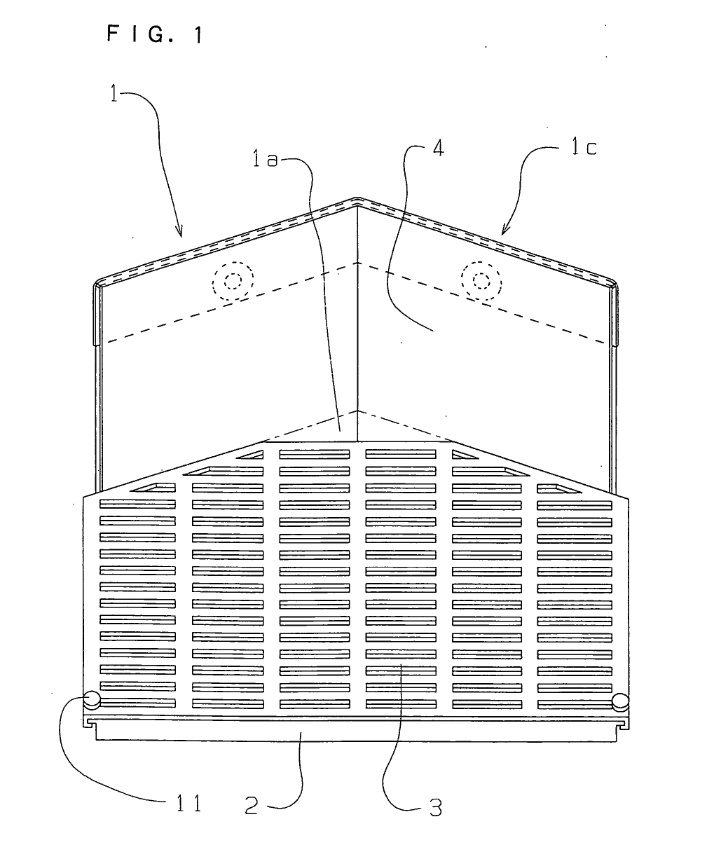

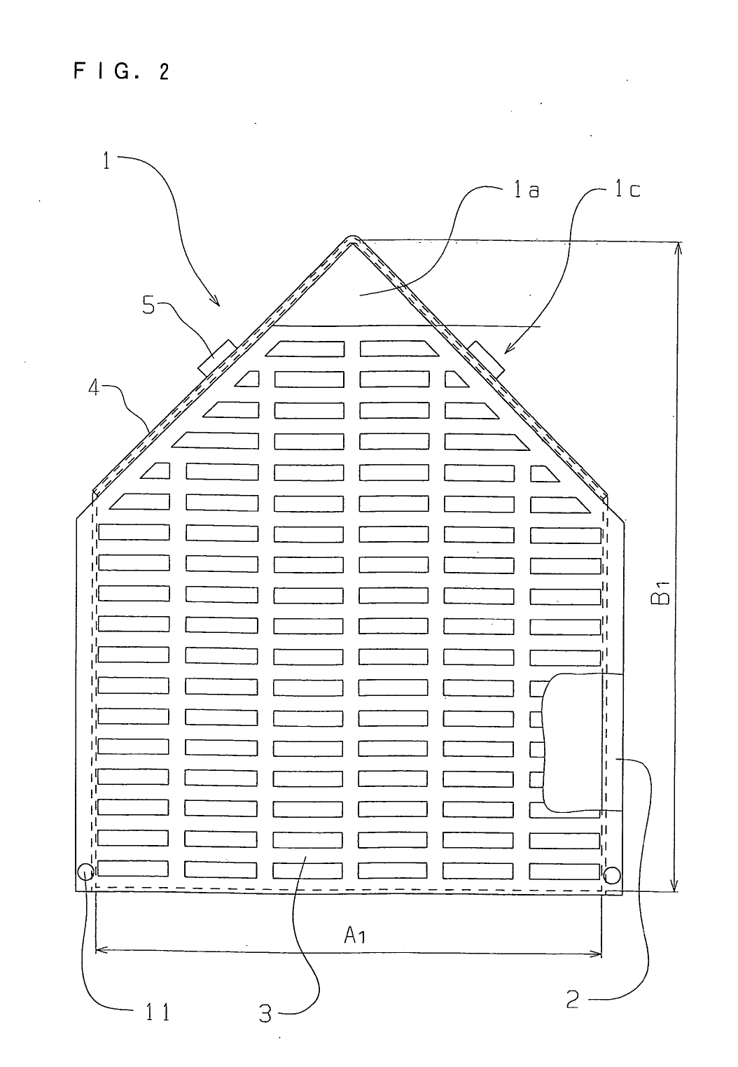

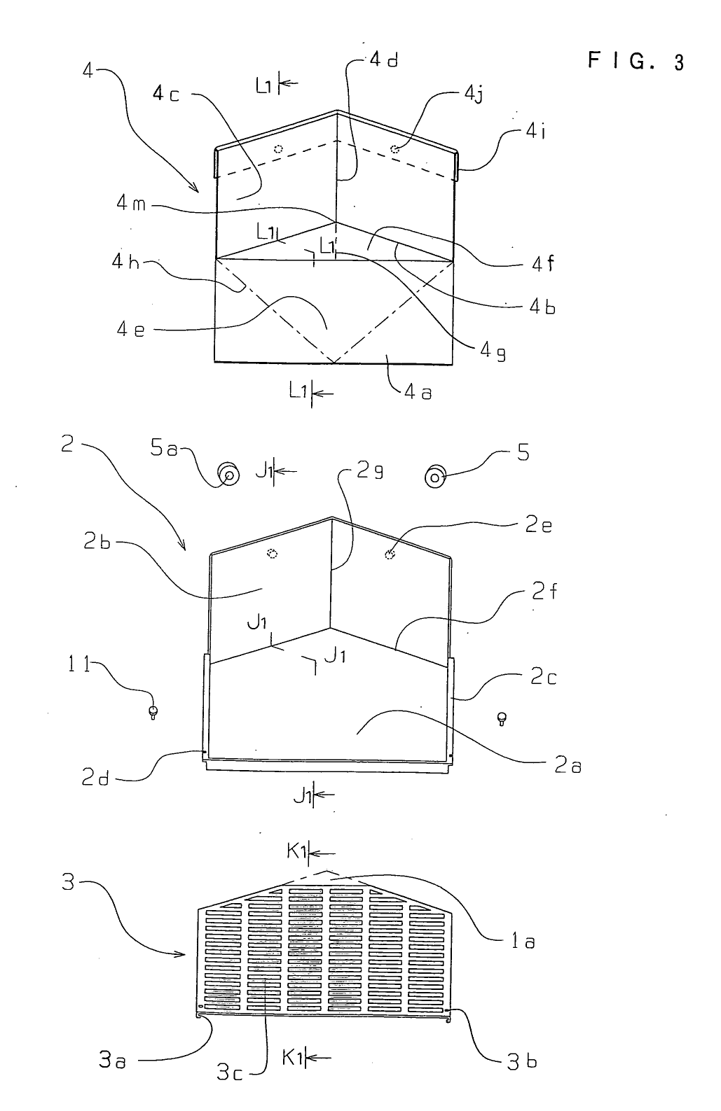

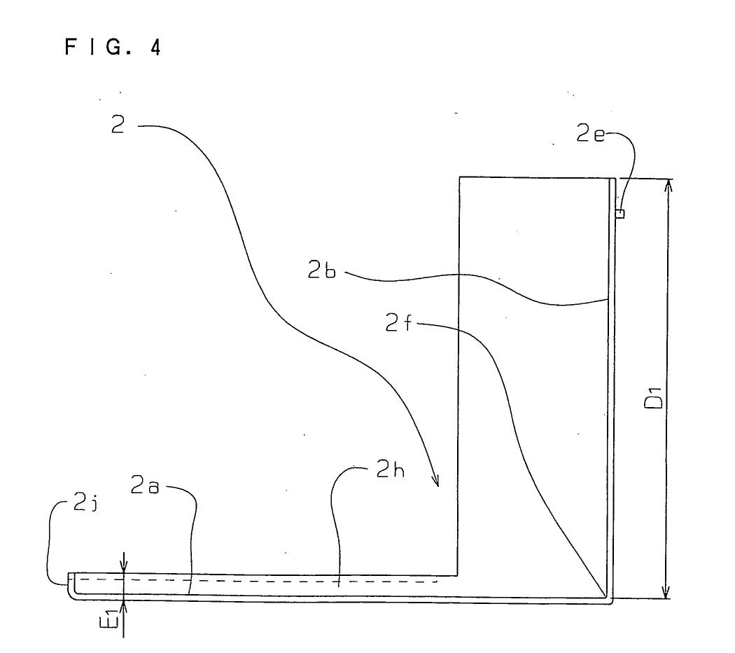

### DETAILED DESCRIPTION OF THE PREFERRED EMBODIMENT

### Embodiment 1

A toilet 1 for a pet according to Embodiment 1 is composed of a waste receptacle 2, a draining board 3 operating as a covering member, and a urine absorbent mat 4. Herein, the width of the waste receptacle 2 is A₁: 250 mm, and the depth thereof is B₁: 315 mm. The waste receptacle 2 presents a roughly house base-shaped profile in its plan view.

The waste receptacle 2 is composed of a receiving tray 2a and a screen 2b. The screen 2b is vertically linked to the position of the inclination sides 2f of the receiving tray 2a. The height of the screen 2b is D₁:200 mm. The screen 2b is constructed to be folded or bent at 90 degrees in its plan view with the ridgeline 2g regarded as the boundary. Two bolts 2e are attached to the upper rear side position of the screen 2b.

The first and second vertical brims 2h and 2j are provided at the sides other than the inclination sides 2f of the receiving tray 2. The height of both the vertical brims 2h and 2j is E₁: 15 mm. A pair of opposed edge parts 2c extending outwards are formed by bending the upper end of the second vertical brim 2h, and the respective edge parts 2c are provided with a pin opening 2d.

The draining board 3 has a hexagonal lattice-like draining board surface 3c which is obtained by cutting off a triangular space 1a from the outer profile of the waste receptacle 2, that is, a roughly house base-shaped profile.

A pair of rail parts 3a opposing each other are formed at both the side edges of the draining board 3. Pin holes 3b corresponding to the pin openings 2d are formed on the rail part 3a.

The urine absorbent mat 4 is composed of a flat part 4a that is roughly house base-shaped in its plan view, and screens 4c vertically linked to the inclination sides 4b at two sides of the flat part 4a. The screens 4c are constructed to be folded or bent at 90 degrees in its plan view with the ridgeline 4d regarded as the boundary. The flat part 4a is composed of two types of paper. That is, a rectangular-shaped front area 4e composed of highly absorbent paper and a rectangular triangle-shaped rear area 4f composed of cardboard whose surface is made smooth. Folding lines 4g and 4h used for folding the absorbent mat 4 are formed at the front area 4e and the rear area 4f. The screen 4c is composed of a cardboard whose surface is made smooth. A hook 4i is formed by folding back the upper part of the screen 4c, and an attaching hole 4j is formed at the hook 4i.

Hereinafter, a description is given of actions of the toilet 1 according to Embodiment 1.

When assembling the toilet 1 for a pet, the urine absorbent mat 4 is set at the front side position of the waste receptacle 2. For the assembling, the hook 4i is hung on the screen 2b of the waste receptacle 2 while placing the flat part 4a of the urine absorbent mat 4 on the receiving tray 2a. At this time, the bolt 2e formed on the screen 2b is passed through the attaching hole 4j. And, a nut 5 is mounted to the bolt 2e exposed rearward from the attaching hole 4j.

Next, the draining board 3 is fixed on the receiving tray 2a of the waste receptacle 2. First, the rail part 3a at the draining board 3 side is fitted to the edge part 2c of the receiving tray 2a side, and the draining board 3 is caused to slide. With the positions of the pin holes 2d and 3b between both made coincident with each other, pins 11 are driven into these pin holes 2d and 3b.

In particular, since a pet ferret is in the habit of defecating at a corner area of the raising chamber, it is not necessary to forcibly train the ferret with regard to a place of defecation, wherein if such a toilet 1 is disposed at a corner area of the raising chamber, the ferret itself will use the toilet 1 as its defecation place. In detail, when a ferret defecates, urine flows to the receiving tray 2a through the draining board surface 3c, and the majority of feces drops at the corner area of the rear area 4e through the triangular space 1a. However, portions thereof are scattered sideward and will adhere to the screen 4c.

Since the toilet 1 is constructed as described above, the following effects can be brought about by Embodiment 1.
(1) Feces defecated by a pet are concealed beneath the draining board 3 and are not conspicuous. Also, since urine is absorbed in the front area 4e, the urine can be removed by removing the urine absorbent mat 4 along with feces dropped on the rear area 4e and adhered to the screen 4c.
(2) Since the surface for which there is a possibility for a pet to touch is constructed of cardboard whose surface is made smooth, there is no case where the urine absorbent mat 4 is broken even if a pet that likes to scratch or claw the cardboard becomes mischievous.
(3) Since the draining board 3 is firmly fixed on the receiving tray 2a of the waste receptacle 2, there is no case where the draining board 3 is removed even if a pet becomes mischievous.
(4) The urine absorbent mat 4 can be made sheet-shaped from a cubic state by folding down the screens 4c at the positions of the ridgeline 4d and the folding lines 4g and 4h.

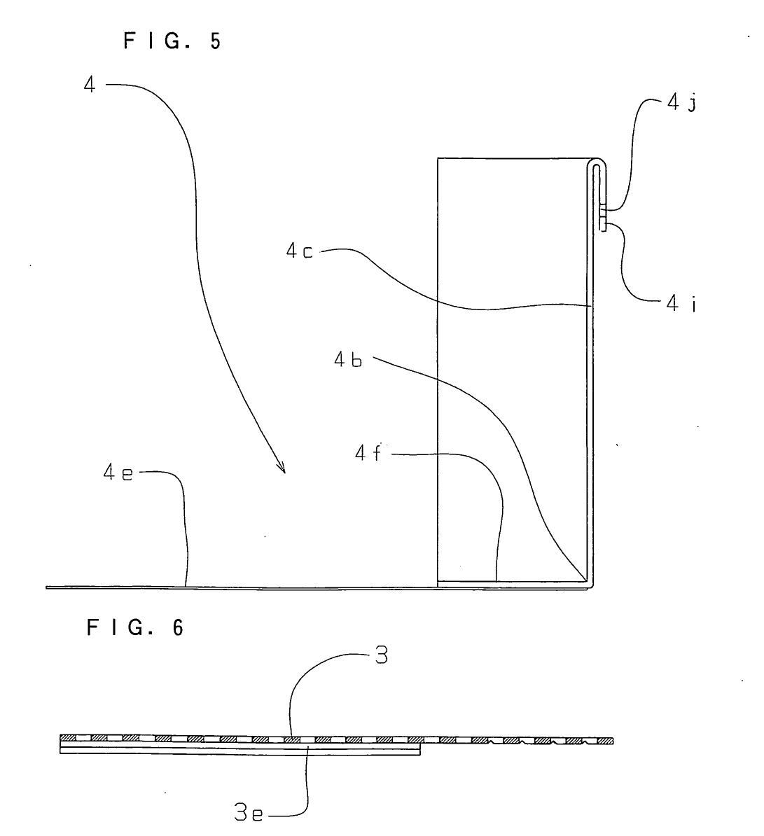

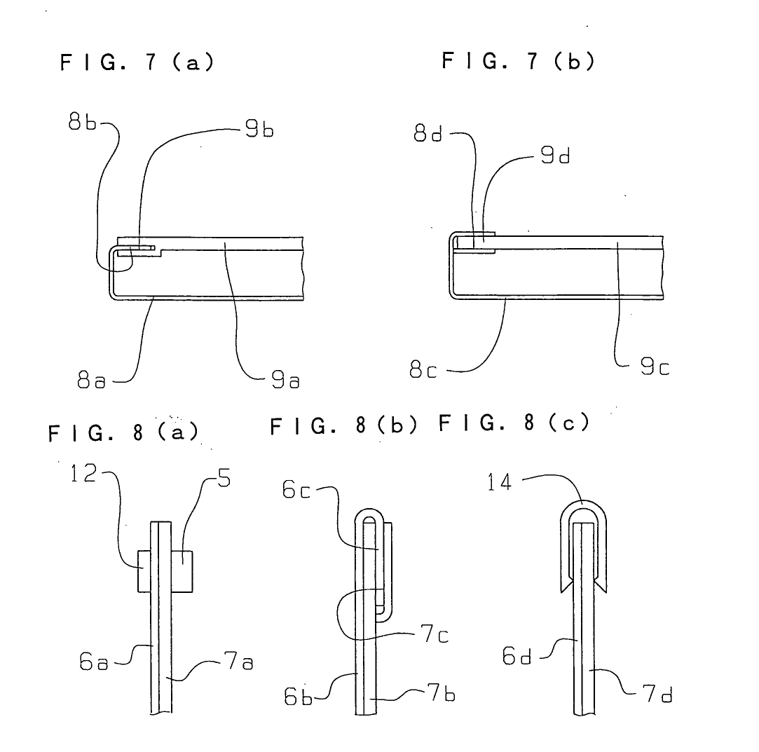

With Embodiment 1 described above, a holding mechanism is constructed at the edge part 2c at the receiving tray 2a side and the rail part 3a at the draining board 3 side. However, as shown in FIG. 7a, the holding mechanism may be composed of the edge part 8b obtained by inwardly folding the receiving tray 8a and at a rail part 9b secured toward the outside of the draining board 9a. Further, as shown in FIG. 7(b), the holding mechanism may be constructed at a rail part 8d secured at the receiving tray 8c side and at both end parts 9d of the draining board 9c.

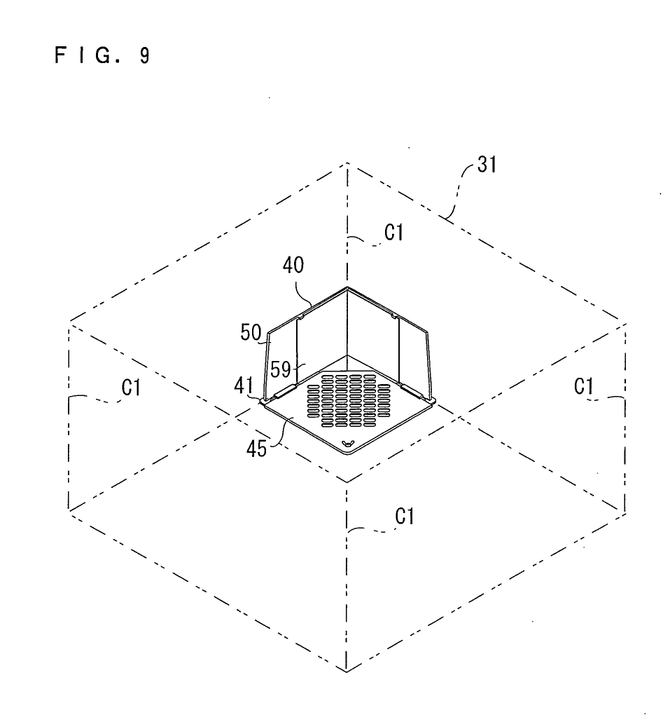

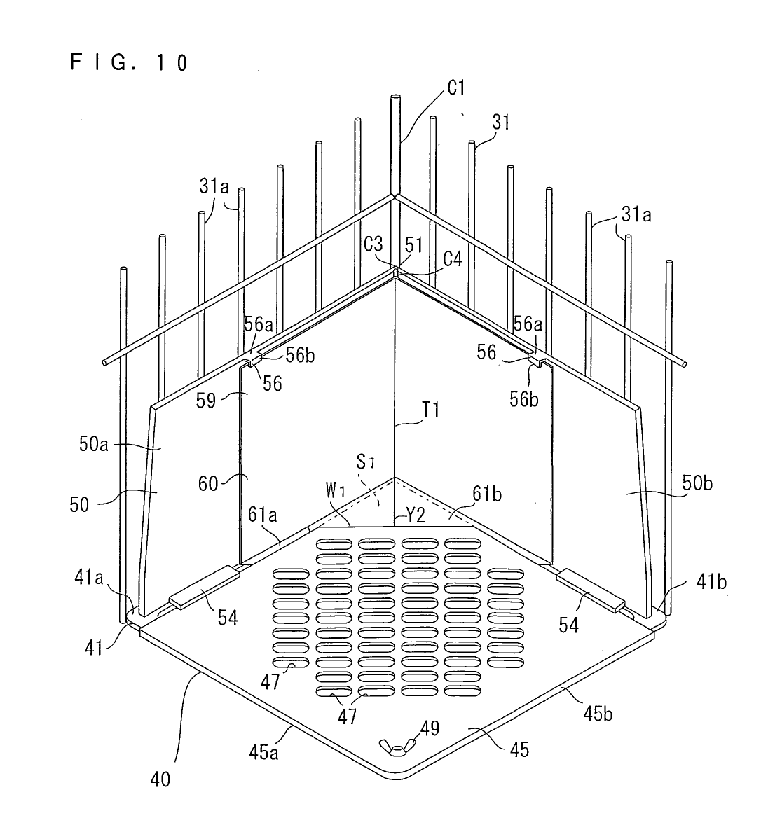

In addition, in Embodiment 1 described above, the fixing mechanism of the waste receptacle mat is composed of bolts 2e, attaching holes 4j and nuts 5. However, as shown in FIG. 8a, the fixing mechanism of the screen 6a and the screen 7a may be composed of bolts 12 and nuts 5. Further, as shown in FIG. 8B, such a fixing mechanism may be employed, in which a recess part 7c is provided outside the screen 7b and a fold-over part 6c is provided at the screen 6b, respectively, and the fold-over part 6c is inserted into the recess part 7c. Still further, as shown in FIG. 8C, a U-shaped spring 14 may be used as the fixing mechanism of the screen 6d and the screen 7d.

### Embodiment 2

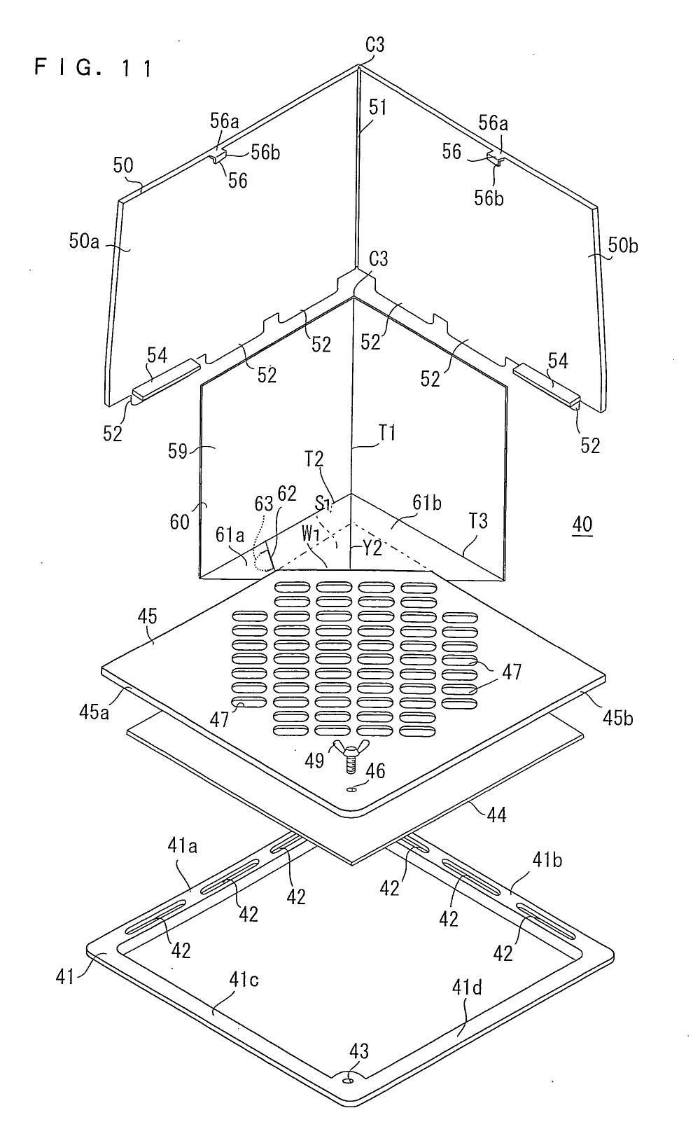

As shown in FIG. 9, a cage 31 is composed in such a manner that a plurality of wire members 31a are disposed lengthwise and crosswise like a lattice. The cage 31 is formed to be quadrangular in its plan view, and is provided with four right angle corner areas C1 therein. A toilet 40 for a pet according to Embodiment 2 is disposed at one corner area C1 of the same cage 31. As shown in FIG. 10 through FIG. 13, a receiving tray 41 that composes a part of the toilet 40 is formed of plastics, and is formed to be rectangular parallelepiped box-shaped with its top openable. The corner area C2 of the receiving tray 41 opposing the corner area C1 of the cage 31 is made roughly right angle-shaped. The first support surfaces 41a and 41b and the second support surfaces 41c and 41d are formed at four edges of the receiving tray 41. These support surfaces 41a, 41b, 41c and 41d are disposed at a higher position than the bottom surface of the receiving tray 41. Long-elliptical slots 42 opening upward are equidistantly provided three by three in the first support surfaces 41a and 41b, respectively. A screw hole 43 opening upward is formed in the vicinity of the crossing part of both the second support surfaces 41c and 41d. A urine absorbent mat 44 composed of paper having high absorbing performance is disposed on the bottom surface of the receiving tray 41.

The receiving tray 41 is covered with the draining board 45 made of plastics and operating as a covering member. The draining board 45 is supported on the support surfaces 41a, 41b, 41c and 41d at the receiving tray 41 side. The draining board 45 is shaped to be roughly coincident with the shape of the receiving tray 41 in its plan view, and only the portion disposed at the corner area C1 of the cage 31 is cut off and is made into a rectangular triangle-shaped opening S1. Therefore, only the portion, opposing the opening portion S1, of the receiving tray 41 is exposed in a state where it is covered by the draining board 45. The regulation parts 45a and 45b are suspended at the front edge part of the draining board 45. The inner faces of the regulation parts 45a and 45b are disposed along the outer edge of the second support surfaces 41c and 41d at the receiving tray 41 side when the draining board 45 is placed on the receiving tray 41. Movement of the draining board 45 in the depth direction is restricted by the regulation parts 45a and 45b being brought into contact with the side of the receiving tray 41. Also, a hole 46 is formed in the draining board 45 at the position corresponding to the screw hole 43 of the receiving tray 41. As shown in FIG. 10 and FIG. 11, a butterfly screw 49 is screwed in the screw hole 43 of the receiving tray 41 via the hole 46.

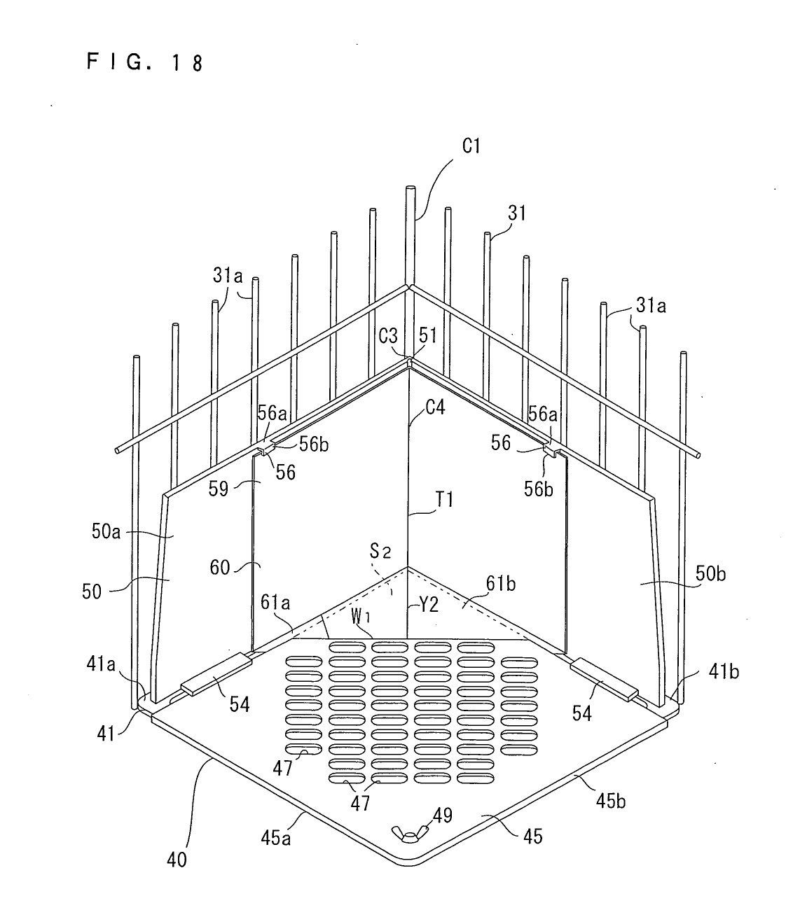

A number of through-holes whose plan view is long slot-shaped are equidistantly formed in the draining board 45. As shown in FIG. 17, on the rear face of the draining board 45, notched grooves 48a and 48b are formed on the extension lines to partition between the through-hole 47 of the first row adjacent to the bottom side W1 of the opening part S1 and the through-hole 47 of the second row, and between the through-hole 47 of the second row and the through-hole 47 of the third row.

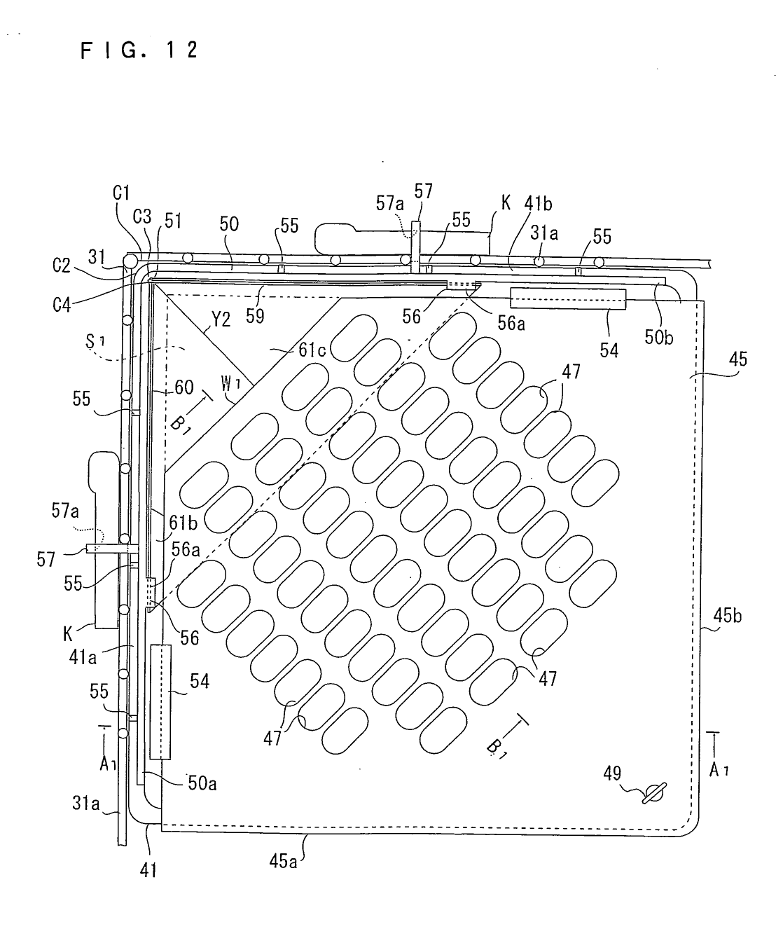

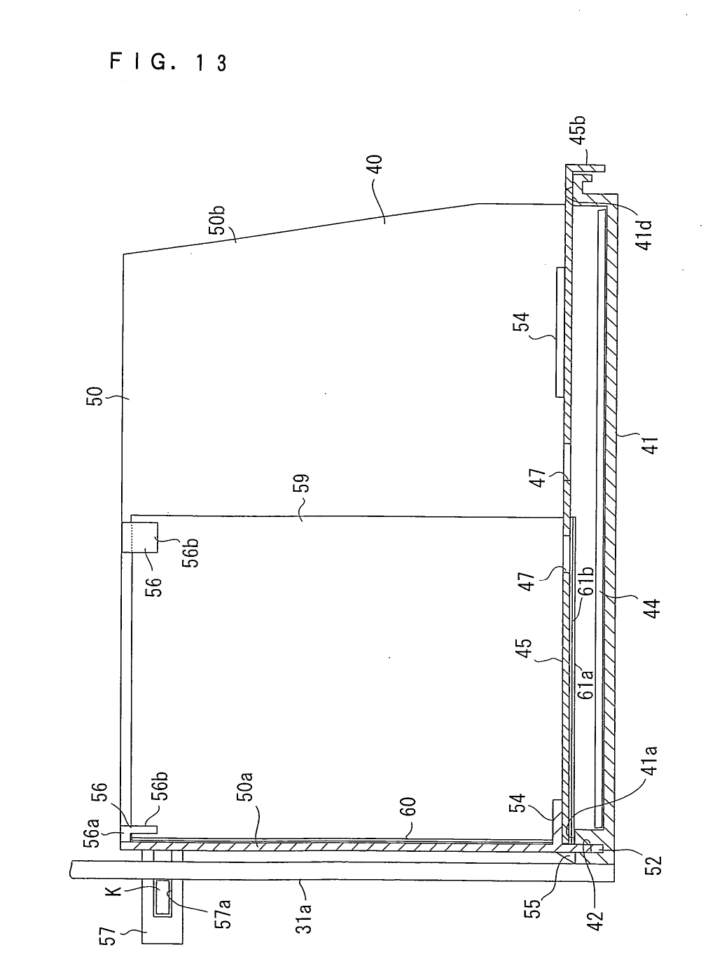

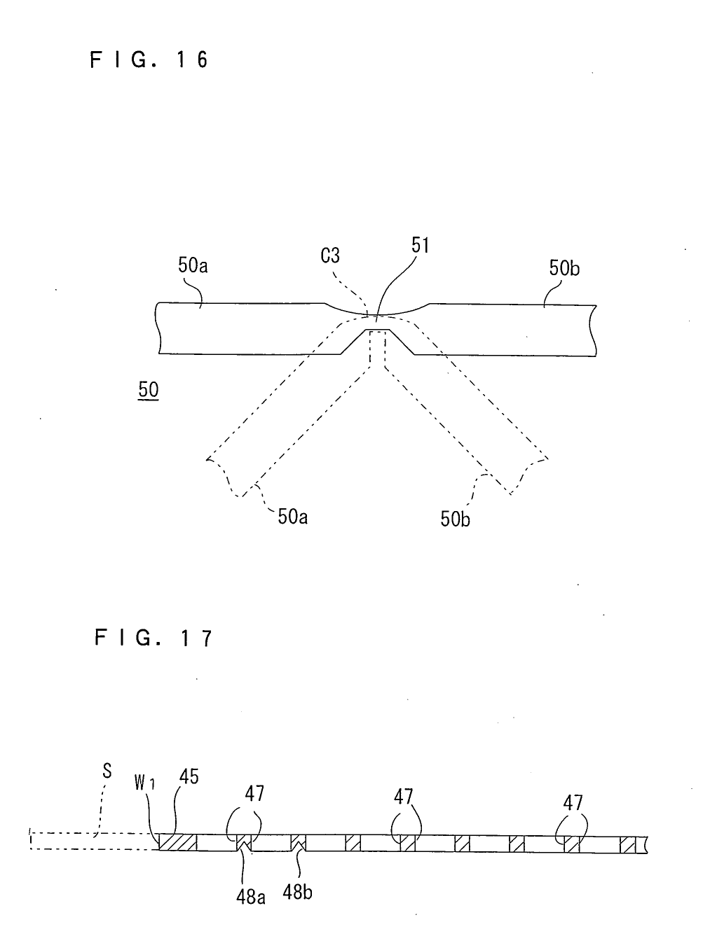

As shown in FIG. 10, FIG. 12 and FIG. 13, a screen 50 operating as the support member is linked to the first support surfaces 41a and 41b of the receiving tray 41. The screen 50 is made of plastics, and, in a non-linked state with the receiving tray 41, the screen 50 is kept to be plate-like in a state shown by a solid line in FIG. 16. Also, a folding part 51 is formed along the perpendicular direction at the center part at the lateral direction of the screen 50. The folding part 51 is made thinner than the thickness of the other portion. In a state where the screen 50 is linked to the receiving tray 41, the screen 50 is held to be roughly at a right angle as shown by an alternate long and two dashed line in FIG. 16. In the present embodiment, the screen 50 at the left portion from the folding part 51 is made into the left side plate 50a, and the screen 50 at the right portion from the folding part 51 is made into the right side plate 50b.

As shown in FIG. 11 and FIG. 13, engagement projections 52 that are engaged in the holes 42 of the receiving tray 41 are formed three by three on the underside of both the plates 50a and 50b.

A pressing claw 54 is formed at a position near the lower end of both the plates 50a and 50b, respectively. The pressing claw 54 is projected inwardly at a position spaced upward from the underside of both the plates 50a and 50b by roughly the same dimension as the thickness of the draining board 45.

As shown in FIG. 12 and FIG. 13, support projections 55 are formed three by three at the outer side at the lower edge position of both plates 50a and 50b. As shown in FIG. 13, the support projection 55 presents a right-angled triangle in its side view, and supports the screen 50 at the back face side thereof.

As shown in FIG. 10 through FIG. 13, an engagement piece 56, whose section is L-shaped, composing a part of a fixing member is formed on the upper inner side of both plates 50a and 50b, respectively. The engagement piece 56 is composed of a linkage part 56a extending in the right angle direction of the inner side face of the plates 50a and 50b and a support part 56b suspended from the tip end of the same linkage part and extending parallel to the inner side face of the plates 50a and 50b.

As shown in FIG. 12 and FIG. 13, a plate linkage piece 57 composing a part of a fixing member is formed outwards on the upper part of the outer side face of both plates 50a and 50b. A through-hole 57a opening parallel to the plate 50a and 50b surfaces is formed at the plate linkage part 57. Also, a locking plate K described later is inserted into the through-hole 57a.

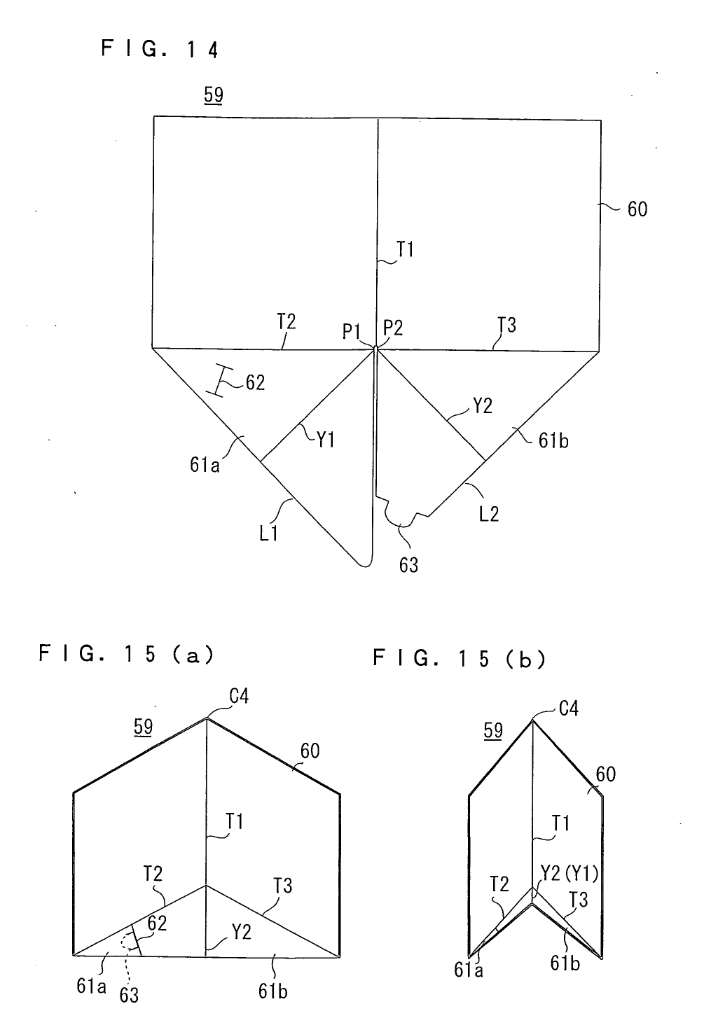

FIG. 14 is a developed view of a disposable sheet 59. The disposable sheet 59 is composed of paper having its surface coated with resin having high water repellency. The disposable sheet 59 is formed of a rectangular screen 60 whose width is long, a first storage part 61a and a second storage part 61b, which are provided at the lower part of the same screen 60. The first inward folding line T1 operating as a division line extending in the up and down direction is provided at the center part in the lengthwise direction of the screen 60, and the part, between the storage parts 61a and 61b, existing on the extension line of the first inward folding line T1 is cut off, and both the storage parts 61a and 61b are divided into two. The second inward folding line T2 operating as a linkage part and the third inward folding line T3 operating as a linkage part at the boundary portion between both storage parts 61a, 61b and the screen 60 are arovided.

In addition, the first outward folding line Y1 operating as the folding-over line is provided so as to be coincident with the perpendicular line connecting the top point P1 of the first storage part 61a to the bottom side L1. Also, a cut-in hole 62 that communicates the surface and the back with each other is formed at the first storage part 61a. The second outward folding line Y2 operating as the folding-over line is provided so as to be coincident with the perpendicular line connecting the top point P2 of the second storage part 61b to the bottom side L2. Also, an insertion portion 63 having roughly the same width as the cut-in width of the cut-in hole 62 of the first storage part 61a is formed at the tip end part of the second storage part 61b.

FIG. 15a shows a state where the first through the third inward folding lines T1 through T3 are inwardly folded, the insertion portion 63 of the second storage part 61b is inserted into the cut-in hole 62 of the first storage part 61a, and the disposable sheet 59 is assembled, that is, the drawing is a perspective view showing the disposable sheet 59 showing a state where the toilet is used. In a state where the disposable sheet 59 is assembled, a shape of the corner area C4 of the screen 60 is kept right-angled as in the respective corner areas C1, C2 and C3. The state of the disposable sheet 59, which is shown in the same drawing, is made into a cubically opened state.

Next, a description is given of one example for installing the toilet 40 in which the respective components and members are assembled.

First, as shown in FIG. 10, FIG. 12 and FIG. 13, a urine absorbent mat 44 is disposed in the receiving tray 41. Next, a draining board 45 is placed on the second support surfaces 41c and 41d of the receiving tray 41. Next, the butterfly screw 49 is screwed in the screw hole 43 of the receiving tray 41 via the screw insertion hole 46 of the draining board 45, whereby movement of the draining board 45 is regulated in regard to the receiving tray 41. Further, the screen 50 is folded at the folding parts 51, and the respective engagement projections 52 are inserted into the respective holes 42 of the receiving tray 41, and the screen 45 is engaged with the receiving tray 41. At this time, the draining board 45 is pressed from its upper surface by means of the pressing claw 54 of the screen 50, wherein the draining board 45 is prevented from being floated at the support surfaces 41a and 41b sides. Also, the screen 50 is prevented from being inclined or tilted rearward since the lower end surfaces of the respective support projections 55 are brought into contact with the first support surfaces 41a and 41b.

Next, respective folding parts of the disposable sheet 59 that is in its developed state of FIG. 14 are folded in predetermined directions, and the insertion portion 63 is inserted into the insertion hole 62. Then, the disposable sheet 59 is assembled as shown in FIG. 15. Next, as shown in FIG. 10, FIG. 12 and FIG. 13, the storage parts 61a and 61b of the disposable sheet 59 are inserted between the first support surfaces 41a and 41b of the receiving tray 41 and the draining board 45. And, the upper part of the disposable sheet 59 is inserted into the engagement piece 56 of the screen 50.

Next, as shown in FIG. 9, FIG. 10, FIG. 12 and FIG. 13, the corner area C2 at which the first support surfaces 41a and 41b of the receiving tray 41 are intersected with each other is matched with the corner area C1 of the cage 31, and the toilet 40 is arranged in the cage 31. And, as shown in FIG. 12 and FIG. 13, a locking plate K is inserted into the plate insertion hole 57a of the plate linkage part 57 of the screen 50 exposed outside the cage 31, respectively. In this state, the locking plate K is brought into contact with the wire members 31a of the cage 31, which are arrayed in the longitudinal directions, and operates as a stopper, wherein the toilet 40 is prevented from being separated and spaced from the cage 31.

The toilet 40 is installed as described above. Next, a ferret is released in the cage 31. The ferret defecates and urinates at the one of 4 corner areas in the cage 31 as is its habit. Therefore, when the ferret defecates or urinates, it may moves to the toilet 40 side in the cage 31. And, when the ferret defecates and urinates, it gets on the draining board 45 and turns its backside to the corner area C1 side of the cage 31. At this time, urine discharged from the ferret is absorbed in the urine absorbent mat 44 in the receiving tray 41 through the through-holes 47 of the draining board 45. Also, comparatively large feces discharged therefrom land on the storage parts 61a and 61b of the disposable sheet 59, which are exposed to the opening S1 of the draining board 45. In addition, feces scattered rearward, which do not land on the storage parts 61a and 61b, are received by the screen, wherein the feces are prevented from being splashed outside.

After discharged feces accumulate to some amount, the disposable sheet 59 is removed from the engagement pieces 56 of the screen 50, and the storage parts 61a and 61b are pulled out between the first support surfaces 41a and 41b of the receiving tray 41 and the draining board 45. And, the outward folding parts Y1 and Y2 of the storage parts 61a and 61b are outwardly folded, as shown in FIG. 15B, so that the feces on the storage parts 61a and 61b do not drop down, and the feces land and are held between the screen 60 and the storage parts 61a and 61b, and are disposed. Feces can be prevented from dropping down from the disposable sheet 59 by holding the disposable sheet 59 as described above. Also, the outwardly folded storage parts 61a and 61b become higher at their forward side, wherein the feces are accumulated rearward (that is, near the screen 60), and it becomes hard for feces to drop.

Next, the butterfly screw 49 is removed, and at the same time, the screen 50 is removed from the receiving tray 41. Further, the draining board 45 is removed. And, the urine absorbent mat 44 is replaced with a new (non-used) one. The draining board 45 and the screen 50 are attached again.

In addition, as a raised ferret grows and its body size becomes larger, the draining board 45 is cut off along the notched groove 48a or 48b. Since the draining board 45 is formed of plastics, and at the same time, the notched grooves 48a and 48b shown in FIG. 17 are made thinner than the other parts, the draining board 45 can be easily cut off by hand along the notched grooves. And, after the draining board 45 is cut off along either the notched groove 48a or 48b, the toilet 40 is assembled as in the assembling described above, and the toilet 40 is disposed at the position of the corner area C1 in the cage 31.

FIG. 18 is a perspective view showing the toilet 40, in which the draining board 45 is cut off along the notched groove 48a, disposed in the cage 31, wherein the area of the opening S2 is further enlarged than the area of the opening S1 of FIG. 10. Thus, by enlarging the area of the opening S2, the exposed area of the storage parts 61a and 61b of the disposable sheet 59 is enlarged, and feces discharged by a grown-up ferret can be prevented from being adhered to the draining board 45.

By constructing the toilet 40 as described above, Embodiment 2 can bring about the following effects in addition to the effects of Embodiment 1 described above.
(1) In the draining board 45, a portion close to the corner area C2 of the receiving tray 41 is made into a notched opening S and exposed to cause the storage parts 61a and 61b to appear. And since a ferret defecates toward the exposed portions as is its habit, the draining board 45 is hardly contaminated due to feces. Also, the storage parts 61a and 61b are covered by the draining board 45, excepting the portions close to the corner area C2, there is no case where the ferret bites and/or tears the storage parts 61a and 61b, and the storage parts 61a and 61b will not be damaged.
(2) Since the disposing work of feces may be basically only to replace the disposable sheet 59, cleaning work of the toilet 40 can be simplified. Also, since almost no feces adhere to places other than the disposable sheet 59, the washing work of the toilet 40 can be further simplified.
(3) Since outward folding parts Y1 and Y2 are provided at the storage parts 61a and 61b of the disposable sheet 59, respectively, feces discharged on the storage parts 61a and 61b can land and be held between the screen 60 and the storage parts 61a and 61b, wherein it is possible to prevent the feces from dropping from the disposable sheet 59 during the disposing work.
(4) Since the hem (lower part) of the storage parts 61a, 61b of the disposable sheet 59 is disposed so as to be placed between the receiving tray 41 and the draining board 45, the storage parts 61a and 61b can be prevented from rolling up, wherein discharged feces can reliably land on the storage parts 61a and 61b.
(5) Since the area of the opening S is constructed to be variable by providing the notched grooves 48a and 48b on the rear side of the draining board 45, it is possible to change the area of the opening S in line with growth of a ferret without preparing a plurality of draining boards having different areas in the opening S. Accordingly, a decrease in cost can be achieved, and it is not necessary to control the stock of draining boards of different openings S.
(6) The toilet 40 according to the present embodiment is composed of a receiving tray 41, a draining board 45, a screen 50, a urine absorbent mat 44, a disposable sheet 59, a butterfly screw 49, and a plate K, and these components can be disassembled, wherein the toilet components can be put away and stored in a small space.
(7) Since inward folding parts T1 through T3 and outward folding parts Y1 and Y2 are provided at predetermined positions of the disposable sheet 59, insertion holes 62 and insertion portions 63 are also provided, and the insertion portion 63 is inserted into the insertion hole 62 after being folded into a predetermined shape, it is possible to form a cubic disposable sheet 59 of a single sheet of paper. Therefore, since disposable sheets 59 before assembling can be stored in a developed state, the disposable sheet 59 is not made bulky and can be stored in a small space. Further, the disposable sheet 59 can be assembled without any adhesive agent, etc., it is possible to simplify the assembling work thereof.
(8) Since the plate linkage piece 57 is provided at the outside surface of the screen 50, and movement of the toilet in regard to the cage 31 is regulated by inserting an exclusive plate Kinto the plate insertion hole 57a, the toilet 40 can be prevented from moving and being overturned with respect to the cage 31 even if the ferret collides with the toilet 40 or scratches the same, and it is possible to prevent the interior of the cage 31 from being contaminated due to feces and urine.

Further, the present invention may be embodied as described below.
(1) The invention maybe embodied for pets other than a ferret.
(2) In Embodiment 2, the receiving tray 41 may be embodied with a planar shape other than a rough square. That is, the shape of the receiving tray 41 may be appropriately changed and embodied so as to correspond to the corner area C1 of the cage 31. In this case, the planar shape of the draining board, number and shape of respective folding lines of the disposable sheet 59 may be changed so as to correspond thereto.
(3) In Embodiment 2 described above, the shape of through-holes 47 of the draining board 45 operating as the covering member may be embodied with an elliptical shape, a rectangular shape, and other various types of shapes other than the long slot.
(4) Embodiment 2 described above may be embodied without use of the screen 50 operating as a support member.
(5) Embodiment 2 described above may be embodied without providing the notched grooves 48a and 48b on the rear side of the draining board 45 operating as the covering member.
(6) Embodiment 2 described above may be embodied without providing the engagement piece 56 at the screen 50 operating as a support member.
(7) Embodiment 2 described above may be embodied with a glass-fabricated box-like enclosure other than the cage 31.
(8) Means for holding a cubic shape may be composed by forming a notch in both the storage parts 61a and 61b of the disposable sheet 59 and crossing the notches of both of the storage parts 61a and 61b when assembling the disposable sheet 59.
(9) Embodiment 2 described above may be embodied with an enclosure having a corner area formed to be a curved surface and an obtuse-angled or an acute-angled corner area although the corner area C1 of the cage 31 operating as the enclosure is flat and right-angled. In this case, the planar shape of the respective members such as the receiving tray 41 and disposable sheet 59 is formed so as to correspond to the shape of the corner area of the enclosure.
(10) In Embodiment 2 described above, the disposable sheet 59 may be assembled by using an adhesive agent or an adhesive tape without providing the insertion hole 62, etc., as means for holding a cubic shape in the disposable sheet 59.
(11) In Embodiment 2 described above, the material of the disposable sheet 59 may be formed of, for example, foldable thin vinyl chloride sheet and PET (polyethylene terephthalate) other than paper.
(12) In Embodiment 2 described above, the disposable sheet 59 may be embodied with a plurality of sheets of paper.
(13) In Embodiment 2 described above, although the plate linkage piece 57 and locking plate K are used to prevent the toilet 40 from moving with regard to the cage 31, a structure other than the above may be used to prevent the toilet 40 from moving with regard to the cage 31 without using the above members.
(14) Embodiment 2 described above may be embodied without using the urine absorbent mat 44.
(15) Embodiment 2 described above maybe embodied by disposing a toilet 40 at respective corner areas C1 of the cage 31.

The invention may be subjected to various modifications and variations within the scope not departing from the spirit thereof.

What is claimed is:

1. A pet toilet, disposed at a corner area in an enclosure in which a pet is accommodated, for a pet having the habit of defecating or urinating at a corner area of the enclosure, comprising:
a receiving tray having a corner area shaped roughly along the shape of a corner area of the enclosure;
a covering member placed above the receiving tray so as to cover the upper surface of the receiving tray, having a portion, which is at a corner area adjacent to the corner area of the enclosure, cut off, and simultaneously including a number of through-holes penetrated from the surface to the back thereof; and
a disposable sheet disposed on the receiving tray and including a storage part for receiving excrement, a screen erected at the base part side of the storage part, and a linkage part to link the storage part and the screen with each other;
wherein the storage part has its upper surface partially exposed at a portion close to a corner area of the receiving tray and is covered by the covering member at a portion spaced from the corner area of the receiving tray.

2. The pet toilet according to claim 1, wherein the screen of the disposable sheet is shaped to the shape of the corner area of the receiving tray.

3. The pet toilet according to claim 1, wherein the receiving tray includes a support member for supporting the screen from the enclosure side.

4. The pet toilet according to claim 3, wherein the support member includes a fixing member for fixing the screen to the support member.

5. The pet toilet according to claim 3, wherein the support member includes a fixing member for fixing the same on the enclosure.

6. The pet toilet according to claim 4, wherein the support member includes a pressing piece by which the covering member is pressed to the receiving tray.

7. The pet toilet according to claim 1, wherein the covering member includes notched grooves, and the exposure area of the storage part covered by the covering member is made variable by cutting off a part of the covering member at positions of the notched grooves.

8. The pet toilet according to claim 1, wherein a urine absorbent mat is disposed in the receiving tray.

9. The pet toilet according to claim 1, wherein the shape of the receiving tray and the covering member are made roughly coincident with each other, excluding a portion close to the corner area of the enclosure.

10. The pet toilet according to claim 1, wherein the covering member is fixed with regard to the receiving tray detachably by a fixing member.

11. A disposable sheet, which is disposed between a receiving tray and a covering member, for a toilet used for a pet including: a receiving tray having a corner area shaped roughly along the shape of a corner area of an enclosure in which a pet is accommodated; and a covering member placed above the receiving tray so as to cover the upper surface of the receiving tray and having a number of through-holes penetrating from the surface to the back thereof, comprising:
a storage part for receiving excrement, a part of which is exposed at a corner area of the receiving tray when being placed on the receiving tray, and a portion spaced from the corner area of the receiving tray is covered by the covering member;
a screen erected from the base part side of the storage part shaped along the shape of the corner area of the receiving tray; and
a linkage part for linking the storage part and the screen with each other.

12. The disposable sheet for a toilet used for a pet according to claim 11, wherein the storage part and the screen is made variable in shape to a roughly same planar state in which the storage part and the screen are folded or developed with the linkage part used as the base and into a cubic state where the storage part and the screen are disposed so as to be crossed with the linkage part used as the base.

13. The disposable sheet for a toilet used for a pet according to claim 12, including means for holding a cubic state by which the storage part and the screen are held in a cubic state.

14. The disposable sheet for a toilet used for a pet according to claim 13, wherein the screen has a foldable and perpendicularly extending folding line, the storage part is divided into a first section and a second section on the extension line of the folding line, the first section has an insertion part formed therein, and the second section has an insertion hole formed therein, into which the insertion part is inserted, and a cubic state is held by inserting the insertion part into the insertion hole.

15. The disposable sheet for a toilet used for a pet according to claim 12, wherein the screen has a first folding line which is foldable and perpendicularly extends, the storage part is provided with a second folding line on the extension of the first folding line, and the storage part and the screen are turned from a cubically assembled state into a folded state with the first folding line and the second folding line used as the base part.
